(19) United States
(12) Patent Application Publication
(10) Pub. No.: US 2015/0319591 A1
(43) Pub. Date: Nov. 5, 2015

(54) METHODS AND SYSTEMS FOR CONCURRENT NARROWBAND AND WIDEBAND COMMUNICATION

(71) Applicant: MOTOROLA SOLUTIONS, INC, Schaumburg, IL (US)

(72) Inventors: YADUNANDANA N. RAO, Sunrise, FL (US); SPYROS KYPEROUNTAS, Weston, FL (US)

(73) Assignee: MOTOROLA SOLUTIONS, INC, SCHAUMBURG, IL (US)

(21) Appl. No.: 14/266,223

(22) Filed: Apr. 30, 2014

(51) Int. Cl. H04W 4/22; H04L 12/28; H04W 72/04

(52) U.S. Cl. CPC H04W 4/22; H04W 72/0453; H04L 12/2856

(57) ABSTRACT

Disclosed herein are methods and systems for concurrent narrowband and broadband communication. An embodiment takes the form of a method that involves generating a narrowband public-safety-radio (PSR) signal for transmission on a downlink of a PSR network. The method further involves generating a multicarrier wideband signal for transmission on a downlink of a wireless wide area network (WWAN), where the multicarrier wideband signal includes a null DC subcarrier. The method also involves producing a combined signal that includes the superposition of (i) the narrowband PSR signal centered on a characteristic frequency of the null DC subcarrier and (ii) the multicarrier wideband signal. Additionally, the method involves transmitting the combined signal for receipt of the narrowband PSR signal at the characteristic frequency by at least one public-safety radio and receipt of the multicarrier wideband signal by at least one WWAN access terminal.

### BACKGROUND OF THE INVENTION

Wireless-communication devices, such as cell phones, smart phones, and mobile WiFi hotspots, are generally configured with the ability to obtain one or more types of wireless service. For example, some such devices are configured to be able to obtain telephony service and/or data service from one or more public-safety radio (PSR) networks (PSRNs). As another example, some such devices are configured to be able to obtain telephony service and/or data service from one or more wireless wide-area networks (WWANs). Furthermore, some wireless-communication devices are configured to be able to obtain wireless services from one or more PSRNs and also from one or more WWANs. And certainly there are other examples of wireless-communication devices, wireless networks, and types of wireless service.

Wireless communication from a wireless network to one or more wireless-communication devices is typically referred to as being “downlink” communication, whereas wireless communication from a given wireless-communication device to a wireless network is typically referred to as being “uplink” communication. Furthermore, some types of wireless communications are generally referred to as being “narrowband” communications, while other types of wireless communications are generally referred to as being “wideband” communications. These are relative terms, in that a wideband form of communication typically occupies a larger portion of the electromagnetic spectrum than does a narrowband form of communication. Moreover, it is often the case that PSRNs are implemented as narrowband networks, while WWANs (e.g., LTE networks) are often implemented as wideband networks. Accordingly, there is a need for concurrent narrowband and wideband communication.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 depicts an example communication system.

FIG. 2 depicts an example public-safety radio network via which one or more mobile radios can communicate.

FIG. 3 depicts an example wireless wide-area network (WWAN) via which one or more mobile radios can communicate.

FIG. 4 depicts an example computing and communication device.

FIGS. 5 through 8 illustrate various different network configurations that each include a source of a public-safety-radio signal.

FIGS. 9 and 10 depict example transmitters.

FIG. 11 depicts an example receiver.

FIG. 12 depicts an example method.

FIG. 13 depicts an example combined signal that includes a superposition of a narrowband public-safety-radio signal and a multicarrier wideband signal.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION OF THE INVENTION

Disclosed herein are methods and systems for concurrent narrowband and broadband communication. An embodiment takes the form of a method that involves generating a narrowband public-safety-radio (PSR) signal for transmission on a downlink of a PSRN. The method also involves generating a multicarrier wideband signal for transmission on a downlink of a WWAN, where the multicarrier wideband signal comprises a null DC (Direct Current) subcarrier. The method also involves producing a combined signal that includes the superposition of (i) the narrowband PSR signal centered on a characteristic frequency of the null DC subcarrier and (ii) the multicarrier wideband signal. The method also involves transmitting the combined signal for receipt of the narrowband PSR signal at the characteristic frequency by at least one public-safety radio and receipt of the multicarrier wideband signal by at least one WWAN access terminal.

In the narrowband PSRN context, a typical spacing between channels (i.e., a typical channel width) on the downlink is on the order of 12.5 kilohertz (kHz) or perhaps 25 kHz, where a channel of such a size may be used for a one-to-one or one-to-many (i.e., broadcast) communication between a narrowband transmitter and one or more narrowband receivers. And while wideband carrier frequencies may occupy on the order of multiple megahertz (MHz), it is often the case that such relatively large sections of the spectrum are subdivided in various ways to provide what is known in the art as multiple access. One approach for providing multiple access to a wideband downlink signal is known as orthogonal frequency division multiple access (OFDMA), which involves subdividing the spectral resource into what are known as subcarriers, each being spaced from its neighboring subcarriers using a subcarrier spacing that is often on the order of 15 kHz (as is the case with LTE) or the like.

Thus, it is often the case that the channel spacing (i.e., channel width) of a given narrowband radio network is similar in scale to the subcarrier spacing of a given WWAN. And while most of the OFDMA subcarriers in a given multicarrier wideband (e.g., LTE) channel are generally used for transmission of signaling and/or user traffic, one or more of those subcarriers may not be used for transmission of any data; such carriers are often referred to as null subcarriers. One such example is the subcarrier located at the center frequency of a given OFDMA (e.g., LTE) WWAN band. This center subcarrier is often referred to as the DC subcarrier or as the null DC subcarrier.

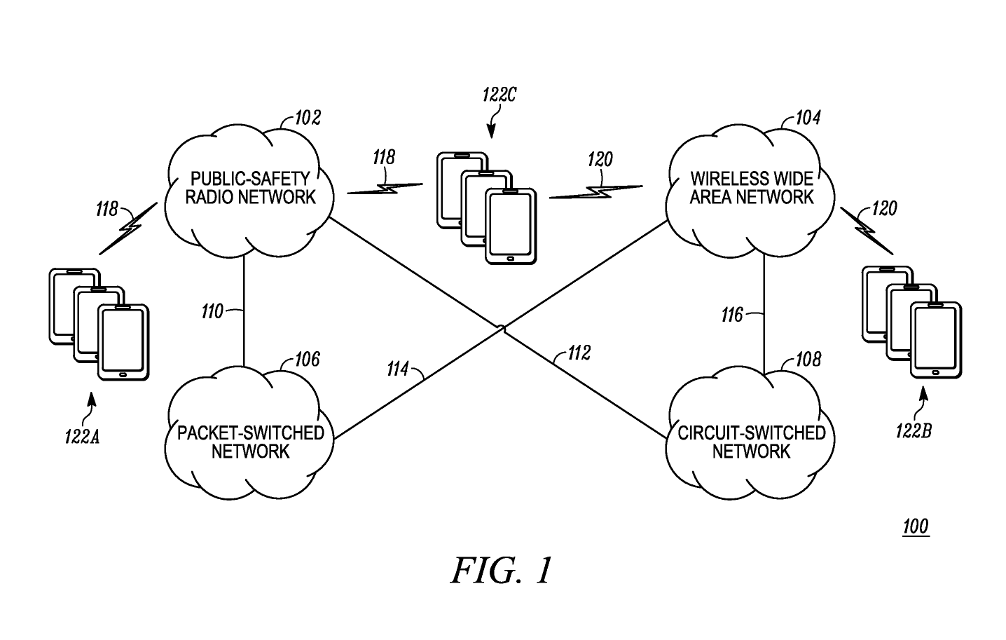

FIG. 1 depicts an example communication system 100 that includes a PSRN 102, a WWAN 104, a packet-switched network (PSN) 106, and a circuit-switched network (CSN) 108, each of which are interconnected via one or more of communication links 110-116. Those having skill in the art will appreciate that communication system 100 may include different and/or additional entities.

PSRN 102 may be any wireless network equipped and configured by those of skill in the relevant art to function as described herein. PSRN 102 could take the form of an Association of Public-Safety Communications Officials-International (APCO) network (such as an APCO-16 network and/or an APCO-25 network), a Digital Mobile Radio (DMR) network, a TErrestrial Trunked RAdio (TETRA) network, and/or an MPT-1327 network, among other possibilities. In general, the downlink channel (or downlink) of PSRN 102 takes the form of a narrowband signal. PSRN 102 could take other forms as well.

WWAN 104 may be any wireless network equipped and configured by those of skill in the relevant art to function as described herein. WWAN 104 could take the form of an LTE network, a Worldwide Interoperability for Microwave Access (WiMAX) network, and/or an IEEE 802.11 (WiFi) network, among other possibilities. In general, the downlink of WWAN 104 takes the form of a multicarrier wideband signal. WWAN 104 could take other forms as well.

In an embodiment, PSRN 102 has a given channel spacing and WWAN 104 has a given subcarrier spacing. For example, PSRN 102 may have a channel spacing of 12.5 kHz and/or 25 kHz, and WWAN 104 may have a subcarrier spacing of 15 kHz, among numerous other examples. In an embodiment, WWAN 104 has a subcarrier spacing that exceeds the channel spacing of PSRN 102. For example, the channel spacing of PSRN 102 may be 12.5 kHz and the subcarrier spacing of the WWAN 104 may be 15 kHz. In an embodiment, PSRN 102 has a channel spacing that exceeds the subcarrier spacing of WWAN 104. For example, the channel spacing of the PSRN 102 may be 25 kHz and the subcarrier spacing of WWAN 104 may be 15 kHz. Indeed, such a scenario is described below as being addressed by having at least one additional null subcarrier deployed adjacent each side of the null DC subcarrier. And certainly numerous other possibilities abound.

PSN 106 could be the worldwide network typically referred to as the Internet, but could just as well be any other packet-switched network equipped and configured by those of skill in the relevant art to function as described herein. Nodes resident on PSN 106 may be Internet Protocol (IP) nodes and may be addressed using IP addresses, as examples. CSN 108 could be the circuit-switched communication network typically referred to as the Public Switched Telephone Network (PSTN), but could just as well be any other circuit-switched network arranged and configured by those of skill in the relevant art to function as described herein.

Any one or more of communication links 110 through 116 could include one or more communication devices, nodes, networks, connections, switches, bridges, routers, and the like. Any or all of communication links 110 through 116 could make use of wired and/or wireless forms of communication. One or more communication links instead of and/or in addition to those depicted could be present.

A given mobile radio could be configured for narrowband communication with PSRN 102, for wideband communication with WWAN 104, or possibly for both narrowband and wideband communication with PSRN 102 and WWAN 104, respectively. In the example depicted in FIG. 1, mobile radios 122A are configured for narrowband communication with PSRN 102 via air interface 118, but are not configured to communicate with WWAN 104. Mobile radios 122B are configured for wideband communication with WWAN 104 via air interface 120, but not for narrowband communication with PSRN 102. Mobile radios 122C are configured for both narrowband and wideband communication with PSRN 102 and WWAN 104 via air interfaces 118 and 120, respectively. Collectively, mobile radios such as mobile radios 122A, 122B, and 122C, also are referred to herein as mobile radios 122 (or individually as a mobile radio 122). It should be understood that additional or fewer mobile radios could be present, and that other configurations are possible.

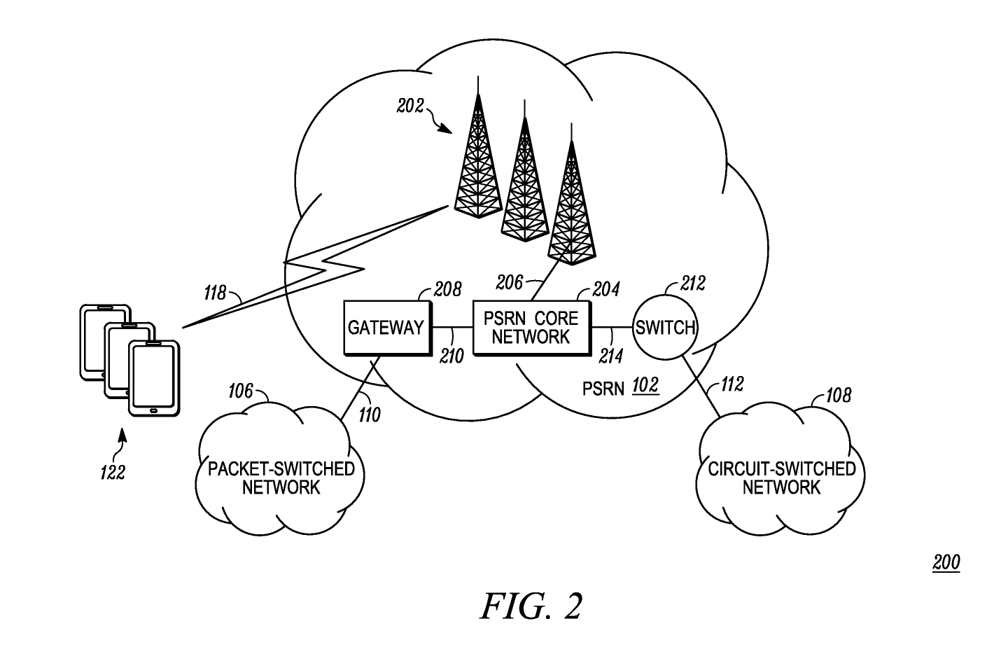

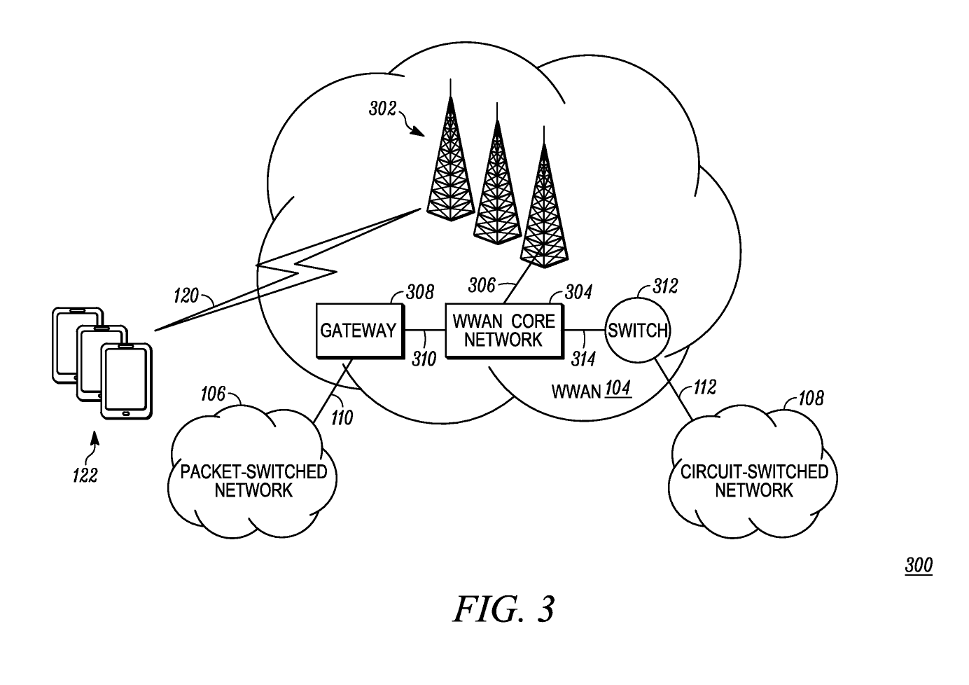

FIG. 2 depicts an example PSRN via which one or more mobile radios can communicate, while FIG. 3 depicts an example WWAN via which one or more mobile radios can communicate. In the embodiment depicted in FIG. 2, PSRN 102 includes a base station 202, a core network 204, a gateway 208, and a switch 212. Core network 204 is connected to base station 202 by communication link 206. Gateway 208 and switch 212 are connected to core network 204 by respective communication links 210 and 214, and are further connected to PSN 106 and CSN 108 by respective communication links 110 and 112. Similarly, the embodiment depicted in FIG. 3 shows WWAN 104 as including a base station 302, a core network 304, a gateway 308, and a switch 312, which are interconnected by communication links 306, 310, and 314 in a manner similar to that of PSRN 102. One or more mobile radios 122 are engaged in wireless communication with PSRN 102 and WWAN 104 via air interfaces 118 and 120, respectively.

Base stations 202 and 302 may be any network-side entities that are suitably equipped and configured by those of skill in the relevant art to function as described herein, which in general is to provide wireless service to mobile radios 122 over air interfaces 118 and 120, respectively. The air interfaces may comply with one or more protocols via which the respective networks provide wireless service.

As known to those of skill in the relevant art, core networks 204 and 304 may include network entities such as one or more mobility management entities (MMEs), one or more home subscriber servers (HSSs), one or more access network discovery and selection functions (ANDSFs), and/or one or more other entities deemed suitable to a given implementation by those of skill in the relevant art. Moreover, these entities may be configured and interconnected in a manner known to those of skill in the relevant art to provide wireless service to mobile radios 122 via respective base stations 202 and 302, and to bridge such wireless service with transport networks such as PSN 106 and CSN 108, perhaps via respective gateways 208 and 308 and/or respective switches 212 and 312.

Gateways 208 and 308 and switches 212 and 312 may be any entities configured to perform the respective gateway and switch functions described herein, which may generally include relaying information among one or more mobile radios, base stations, databases, packet-switched networks, circuit-switched networks, and/or other entities present within and/or connected to respective networks 102 and 104. Moreover, the gateways and switches may be configured as necessary to convert and/or translate between two or more different data types and/or communication protocols; for instance, the gateways and/or switches may be arranged to translate between one or more packet-switched data-communication protocols on the one hand and one or more circuit-switched data-communication protocols on the other hand; and certainly numerous other examples are possible as well.

Communication links 206/306, 210/310, and 214/314 may take any suitable form, such as any of the forms described above in connection with links 110 through 116 of FIG. 1. These links may function as what is known as a “backhaul,” as the links may enable the respective core networks to bridge (i) communications conducted by base station 202/302 with mobile radios 122 over air interface 118/120 with (ii) communications conducted by gateway 208/308 and switch 212/312 with PSN 106 and CSN 108 via communication links 110 and 112. One or more entities such as one or more network access servers (NAS) and/or Voice over IP (VoIP) gateways may reside on any one or more of the communication links to bridge the respective wireless networks to one or more PSNs and/or CSNs.

As known to those of skill in the relevant art, wireless networks 102 and 104 may include additional and/or different entities deemed suitable to a given implementation by those of skill in the relevant art. Moreover, these entities may be configured and interconnected in any manner known to those of skill in the relevant art to provide wireless service to mobile radios via base stations and to bridge such wireless service with transport networks such as PSN 106 and CSN 108. In general, then, other configurations are possible, as those described herein are provided by way of example and not limitation.

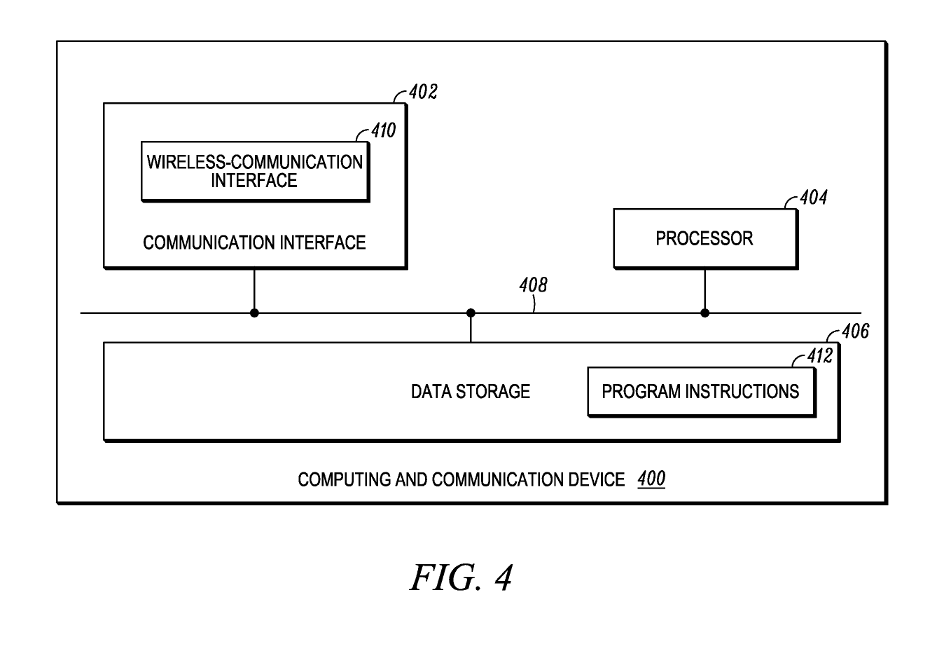

FIG. 4 depicts an example computing and communication device (hereinafter “computing device”). As illustrated, the computing device 400 includes a communication interface 402, a processor 404, and data storage 406, all of which are communicatively linked by a system bus (or other suitable communication path) 408. It should be noted that this example architecture of computing device 400 is presented for illustration and not by way of limitation. Any of the entities described in connection with any of the figures may take the form of the computing device 400 that is depicted in FIG. 4.

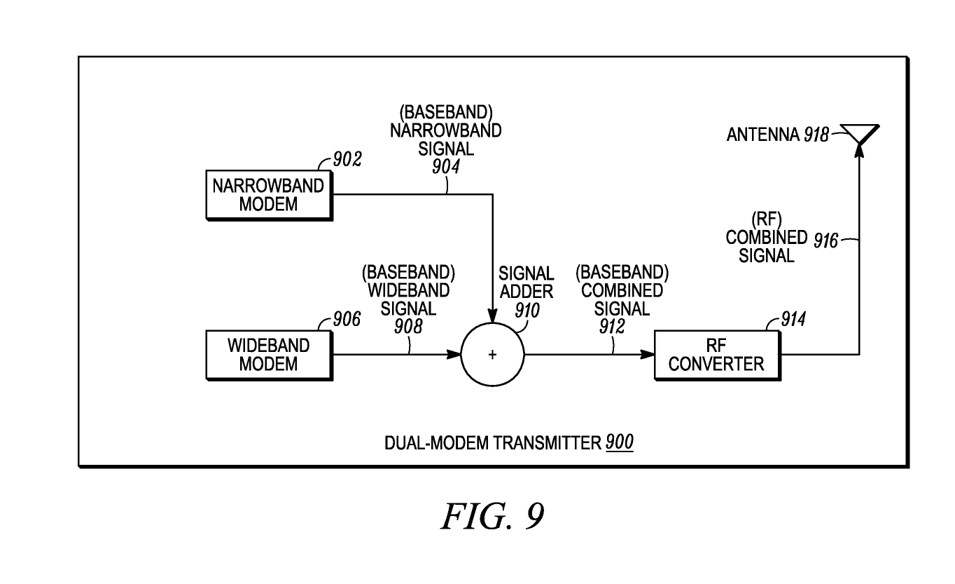

Communication interface 402 is depicted as including a wireless-communication interface 410, which in turn could include components such as one or more antennae, one or more transmitters and/or receivers (such as those discussed below with reference to FIGS. 9, 10, and 11) designed and configured for one or more types of wireless communication, and/or any other components deemed suitable by those of skill in the relevant art. In addition to wireless-communication interface 410, communication interface 402 could further include additional communication-interface technology such as one or more wired (e.g., Ethernet) communication interfaces (not shown) for facilitating communication with various network entities.

Processor 404 may include one or more processors of any type deemed suitable by those of skill in the relevant art, some examples including a general-purpose microprocessor, a dedicated digital signal processor (DSP), and a graphics processor. Data storage 406 may take the form of any non-transitory computer-readable medium or combination of such media, some examples including flash memory, read-only memory (ROM), and random-access memory (RAM) to name but a few, as any one or more types of non-transitory data-storage technology deemed suitable by those of skill in the relevant art could be used. The data storage may contain program instructions 412 executable by processor 404 for carrying out various combinations of the mobile-radio functions described herein. In general, data storage 406 may contain any one or more types of data deemed suitable by those of skill in the relevant art for carrying out the functions described herein.

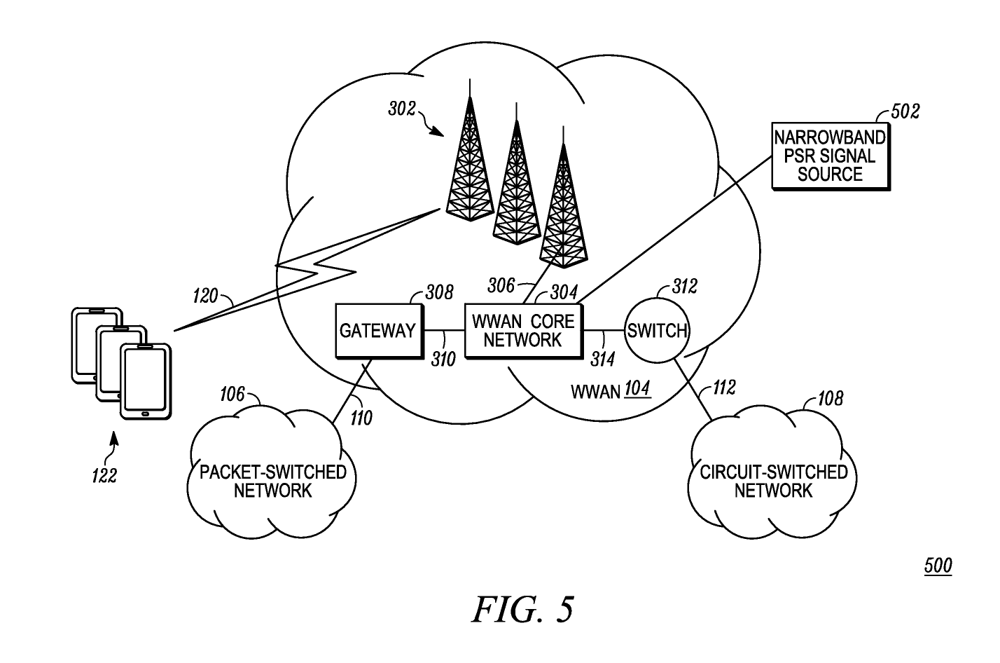

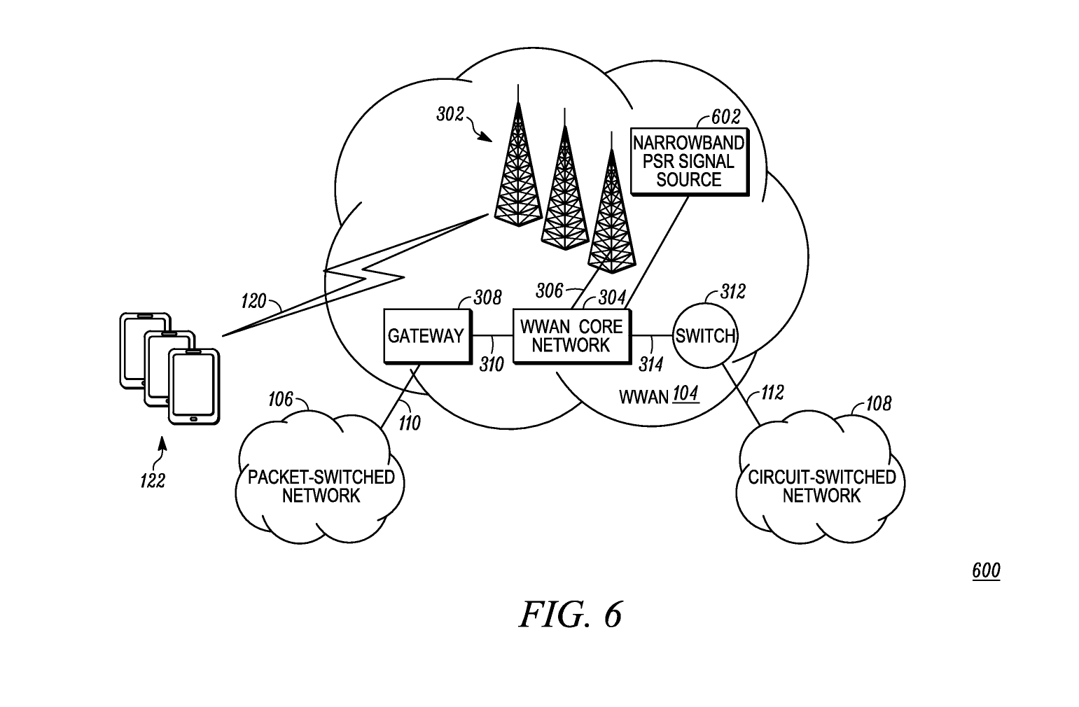

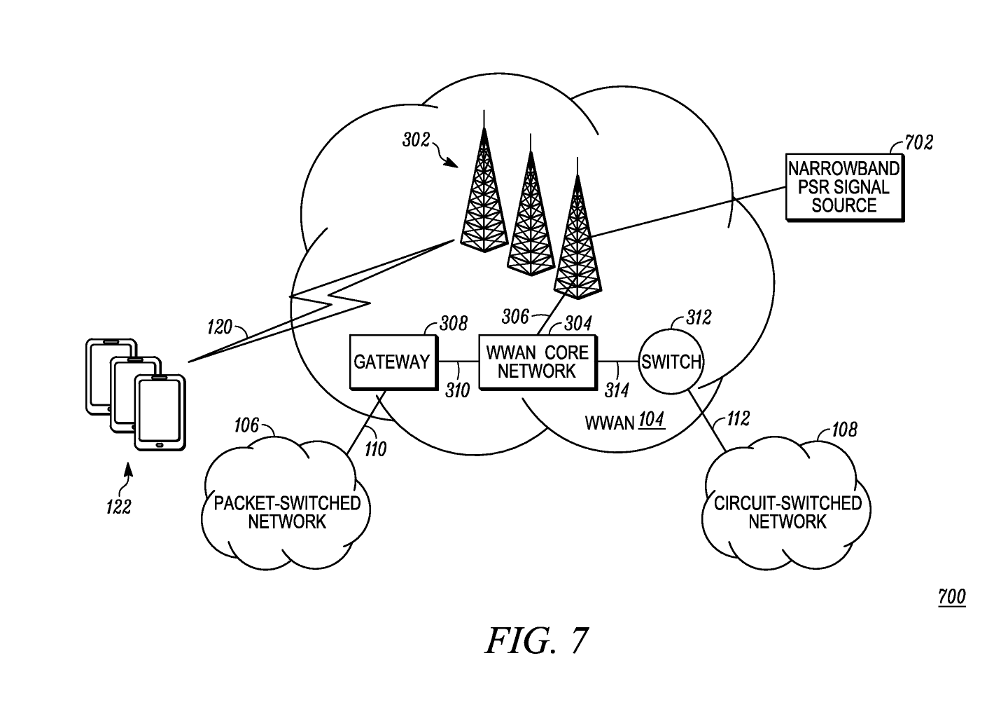

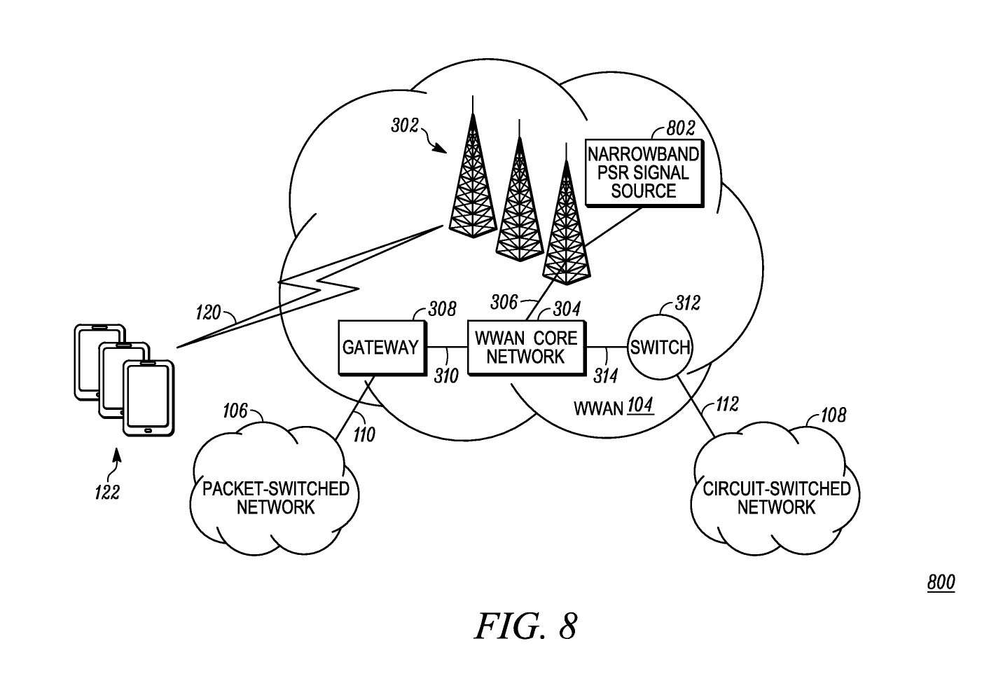

FIGS. 5 through 8 illustrate various different network configurations that each include a source of a public-safety-radio signal. In the embodiment illustrated in FIG. 5, the PSR signal is received at WWAN core network 304 from a narrowband PSR signal source 502 outside of WWAN 104, perhaps via PSN 106 and/or CSN 108. In the embodiment illustrated in FIG. 6, the PSR signal source is received at WWAN core network 304 from narrowband PSR signal source 602 within WWAN 104. In the embodiment illustrated in FIG. 7, the PSR signal source is received at base station 302 from narrowband PSR signal source 702 outside of WWAN 104—perhaps via base station 202 of PSRN 102. In the embodiment illustrated in FIG. 8, the PSR signal source is received at base station 302 from narrowband PSR signal source 702 within WWAN 104. In various different embodiments, a given PSR signal source 502/602/702/802 could be or include a repeater, an entity within or connected to the PSRN core network 204, and/or one or more other suitable narrowband-signal sources deemed suitable by those of skill in the relevant art. Those having skill in the art will appreciate that many other variations are possible as well.

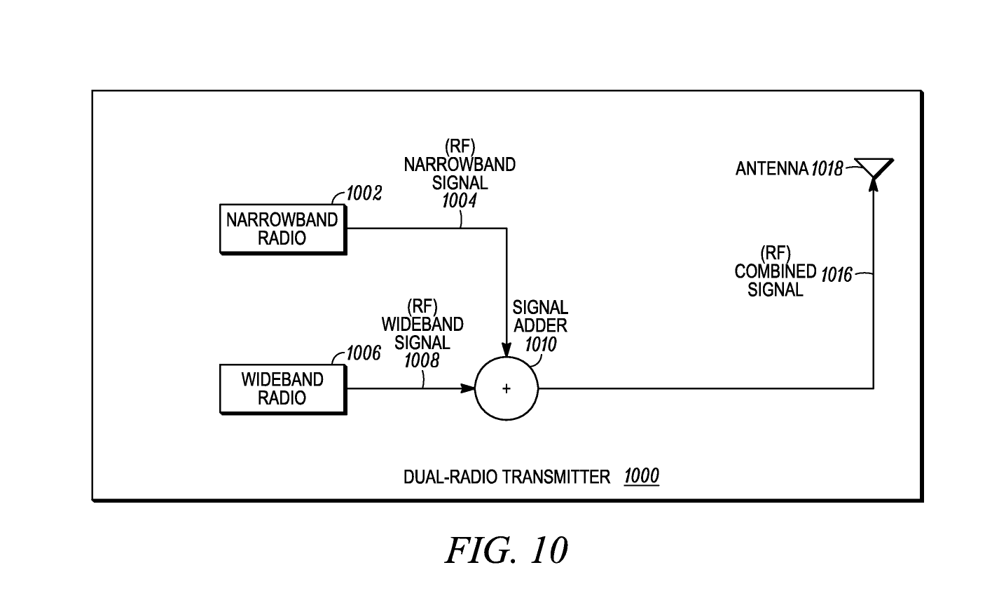

FIGS. 9 and 10 depict example transmitters that could be used in connection with various embodiments. As depicted in FIG. 9, a dual-modem transmitter 900 includes a narrowband modem 902, a wideband modem 906, a signal adder 910, an RF processor 914, and an antenna 918. Modems 902 and 906 could be any devices capable of carrying out the respective modem functions described herein. The modems could be configured to generate a baseband signal (or a signal “at baseband”) that is modulated according to one or more modulation techniques such as OFDM and/or QAM, among other examples. Signal adder 910 may be configured to generate a superposition of two or more signals, and could take the form of a summing amplifier (as just one example). RF processor 914 could be any component capable of up-converting a baseband signal to an RF signal. And antenna 918 may be configured to transmit and/or receive an RF signal.

In the embodiment illustrated in FIG. 9, narrowband modem 902 and wideband modem 906 generate narrowband signal 904 and wideband signal 908, respectively, which are provided to signal adder 910. The signal adder generates a superposition of the received baseband signals, and the combined signal 912 (still at baseband) is provided to RF processor 914. The RF processor 914 up-converts the received baseband signal to an RF signal 916, which may then be provided to another entity (such as antenna 918 for transmission of the RF signal).

As shown in FIG. 10, a dual-radio transmitter 1000 includes a narrowband radio 1002, a wideband radio 1006, a signal adder 1010, and an antenna 1018. Signal adder 1010 and antenna 1018 may operate in a manner similar to the above-described signal adder 910 and antenna 918, respectively, and radios 1002 and 1006 may be configured to generate respective RF signals. In the embodiment illustrated in FIG. 10, narrowband radio 1002 and wideband radio 1006 generate narrowband signal 1004 and wideband signal 1008, respectively, which are provided to signal adder 1010. The signal adder generates a superposition of the received RF signals, and the resulting RF signal 1016 may then be provided to (for example) antenna 1018.

Those having skill in the art will appreciate that dual-modem transmitter 900 and/or dual-radio transmitter 1000 may contain different and/or additional components—for example, additional filtering stages may be added for conditioning the composite signal. Other types of transmitters may be used in addition to (or instead of) transmitters 900 and 1000.

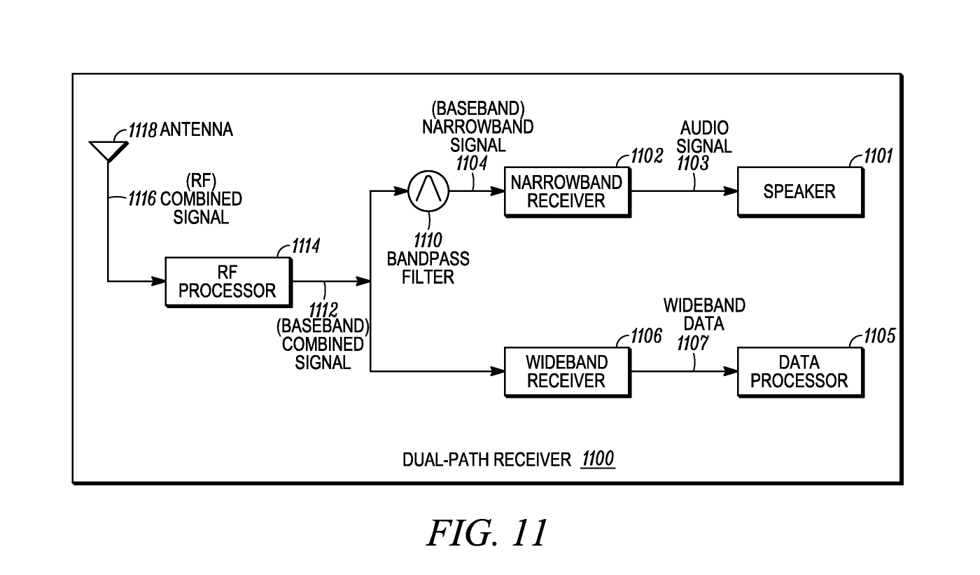

FIG. 11 depicts an example receiver. As shown in FIG. 11, a dual-path receiver 1100 includes an antenna 1118, an RF processor 1114, a bandpass filter 1110, a narrowband receiver 1102, a wideband receiver 1106, a speaker 1101, and a data processor 1105. Antenna 1118 and RF processor 1114 may function in a manner similar to the above-described antenna 918/1018. RF processor 1114 could be any component capable of down-converting an RF signal to a baseband signal. Bandpass filter 1110 may be any component configured to pass frequencies within a certain range and attenuate frequencies outside that range. For example, the bandpass filter may be configured to pass frequencies associated within a given narrowband channel having, e.g., a spacing of 12.5 kHz and/or 25 kHz (among other possible ranges). Receivers 1102 and 1106 may be any components configured to provide narrowband/wideband data to, e.g., a speaker 1101 and/or a data processor 1105.

As shown, RF processor 1114 receives an RF combined signal 1116 via an antenna 1118. The RF processor down-converts the RF combined signal 1116 to produce a combined signal 1112 at baseband. The RF processor 1114 provides the baseband combined signal 1112 to bandpass filter 1110 so as to produce a baseband narrowband signal 1104. Bandpass filter 1110 provides narrowband signal 1104 to narrowband receiver 1102, which may extract therefrom an audio signal 1103 and provide the audio signal 1103 to a speaker 1101. The RF processor 1114 further provides the baseband combined signal 1112 to wideband receiver 1106, which may extract wideband data 1107 contained in the signal and pass the extracted data to, e.g., a data processor 1105. And certainly other configurations are possible.

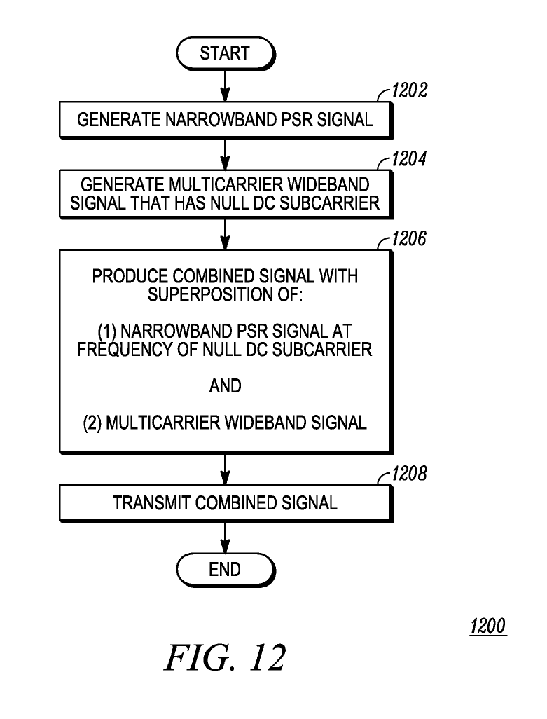

FIG. 12 depicts an example method. In various different embodiments, the method 1200 of FIG. 12 may be carried out by a computing device or system taking the form of the computing device 400 shown in FIG. 4. In some embodiments, this device or system is the WWAN base station 302 of the WWAN 104. The method 1200 is indeed described below as being carried out by the base station 302, though this is by way of illustration and example, not limitation.

As shown, the method 1200 begins at step 1202 with the base station 302 generating a narrowband public-safety-radio (PSR) signal for transmission on a downlink of PSRN 102. In an embodiment, generating the narrowband PSR signal includes receiving the narrowband PSR signal from a repeater or other signal source (perhaps as discussed above with reference to FIGS. 5 through 8). Thus, the present methods and systems can be used in some embodiments as a relay of the narrowband PSR signal (e.g., from the PSRN 102). In an embodiment, generating the narrowband PSR signal includes modulating the narrowband PSR signal.

As noted above, the narrowband PSR signal could be at least one of an APCO signal, a DMR signal, a TETRA signal, and an MPT-1327 signal. The narrowband PSR signal could be on a narrowband channel of PSRN 102. This narrowband channel then is superimposed on a wideband channel at step 1206. This narrowband channel could take the form of (or include) an additional-capacity channel, a dedicated critical information channel, a broadcast channel, and/or a control channel, among numerous other possibilities as will be understood by those of skill in the art. Additionally or alternatively, the narrowband PSR signal could include a direct mode discovery signal, a supplemental channel for supporting at least one service on WWAN 104, and/or an administrative channel for coordination between PSRN 102 and WWAN 104. Those having skill in the art will appreciate that the PSR signal may take other forms as well.

At step 1204, the base station 302 generates a multicarrier wideband signal (e.g., an LTE signal) for transmission on a wideband channel of downlink of WWAN 104. The multicarrier wideband signal includes a null DC subcarrier.

At step 1206, the base station 302 produces a combined signal. The combined signal is a superposition of at least (i) the narrowband PSR signal (generated at step 1202) centered on a characteristic frequency of the null DC subcarrier (of the multicarrier wideband signal generated at step 1204) and (ii) the multicarrier wideband signal (generated at step 1204), or, from another perspective, a superposition of the narrowband channel comprising the PSR signal on the wideband channel comprising the wideband signal. The characteristic frequency of the null DC subcarrier would, as known to those of skill in the art, be the center frequency of the multicarrier wideband signal.

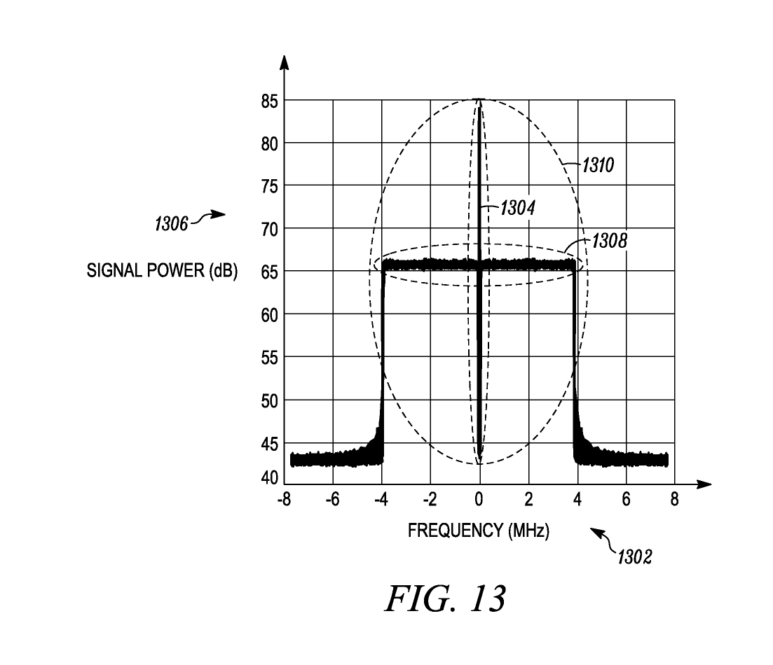

FIG. 13 depicts an example combined signal. In particular, FIG. 13 depicts the spectral power distribution of a combined signal. The horizontal axis 1302 depicts frequency from approximately −8 MHz to approximately +8 MHz, while the vertical axis 1306 depicts signal power from approximately 40 decibels (dB) to approximately 85 dB. As can be seen in FIG. 13, a PSR narrowband signal is depicted at 1304, while a multicarrier wideband signal is depicted at 1308. The superposition of these two signals is indicated at 1310.

Returning to FIG. 12, at step 1208, the base station 302 transmits the combined signal (produced at step 1206) for (i) receipt of the narrowband PSR signal at the characteristic frequency of the null DC subcarrier by at least one public-safety radio and (ii) receipt of the multicarrier wideband signal by at least one WWAN mobile radio.

In an embodiment, PSRN 102 has a channel spacing and WWAN 104 has a subcarrier spacing. For example, in an embodiment, the channel spacing of PSRN 102 exceeds the subcarrier spacing of WWAN 104. For example, the channel spacing of PSRN 102 could be 25 kHz and the subcarrier spacing of WWAN 104 could be 15 kHz. In such a case, where the PSR signal could interfere with the subcarriers adjacent to the DC subcarrier, the base station 302 may select additional subcarriers adjacent to the DC subcarrier to also be null, so as to avoid interference with and/or by the PSR signal. The multicarrier wideband signal could include an equal number of neighboring null subcarriers deployed adjacent each side of the null DC subcarrier. For example, the multicarrier wideband signal could include a single null subcarrier adjacent each side of the null DC subcarrier (for a total of two neighboring null subcarriers, one on each side of the null DC subcarrier, and a total of three consecutive null subcarriers including the null DC subcarrier). The additional subcarrier adjacent each side of the null DC subcarrier might be included if, for example, the channel spacing of PSRN 102 was 25 kHz and the subcarrier spacing of WWAN 104 was 15 kHz.

In an embodiment, the subcarrier spacing of WWAN 104 exceeds the channel spacing of PSRN 102. For example, the channel spacing of the PSRN 102 could be 12.5 kHz and the subcarrier spacing of WWAN could be 15 kHz. Even if the channel spacing of PSRN 102 does not exceed the subcarrier spacing of WWAN 104, the wideband channel could include some equal number of null subcarriers deployed adjacent each side of the null DC subcarrier. Using the above example, the multicarrier wideband signal could include a single null subcarrier adjacent each side of the null DC subcarrier, though other examples are possible.

In an embodiment, the base station 302 selects, based at least in part on a set of one or more factors, a transmission power level of the narrowband PSR signal. The set of one or more factors may include a desired coverage range of the narrowband PSR signal. Additionally or alternatively, the set of one or more factors may include an integer number of neighboring null subcarriers deployed adjacent each side of the null DC subcarrier in the multicarrier wideband signal.

In an embodiment, the base station 302 selects, based at least in part on a set of one or more factors, an integer number of neighboring null subcarriers deployed adjacent each side of the null DC subcarrier in the multicarrier wideband signal. The set of one or more factors could include a desired coverage range of the narrowband PSR signal. Additionally or alternatively, the set of one or more factors could include a transmission power level of the narrowband PSR signal. Those having skill in the art will appreciate that different and/or additional factors may be used as well.

The multicarrier wideband signal may include a plurality of traffic subcarriers, which in turn may include a pair of innermost traffic subcarriers deployed adjacent a respective side of the null DC subcarrier and any neighboring null subcarriers deployed adjacent each side of the null DC subcarrier. In an embodiment, the base station 302 uses a first modulation scheme on the innermost traffic subcarriers and uses a second modulation scheme on the other traffic subcarriers in the plurality of traffic subcarriers. For example, the computing device may use a lower-order modulation scheme on the innermost traffic subcarriers relative to the modulation scheme of the other traffic subcarriers. The computing device might use Quadrature Amplitude Modulation 4 (QAM4) and QAM16, respectively, or QAM16 and QAM64, respectively, among numerous other possibilities. Other modulation schemes may be used as well.

In an embodiment, the base station 302 uses a first error-correction coding scheme on the innermost traffic subcarriers and uses a second error-correction coding scheme on the other traffic subcarriers in the plurality of traffic subcarriers. For example, the computing device may use a strong error correction scheme on the innermost traffic subcarriers relative to the error-correcting coding scheme on the other traffic subcarriers. The error corrections schemes could take the form of respective error-correcting codes, repetition codes, parity bits, checksums, cyclic redundancy checks (CRCs), hash functions, and/or any combination of these, among numerous other possibilities. In an embodiment, computing device 400 uses both a first modulation scheme and a first error-correction coding scheme on the innermost traffic subcarriers and uses both a second modulation scheme and a second error-correction coding scheme on the other traffic subcarriers in the plurality of traffic subcarriers. Other variations are possible as well.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has,” “having,” “includes,” “including,” “contains,” “containing,” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a,” “has . . . a,” “includes . . . a,” “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially,” “essentially,” “approximately,” “about,” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method comprising:
generating a narrowband public-safety-radio (PSR) signal for transmission on a downlink of a PSR network;
generating a multicarrier wideband signal for transmission on a downlink of a wireless wide area network (WWAN), wherein the multicarrier wideband signal comprises a null Direct Current (DC) subcarrier;
producing a combined signal, wherein the combined signal comprises the superposition of (i) the narrowband PSR signal centered on a characteristic frequency of the null DC subcarrier and (ii) the multicarrier wideband signal; and
transmitting the combined signal for receipt of the narrowband PSR signal at the characteristic frequency by at least one public-safety radio and receipt of the multicarrier wideband signal by at least one WWAN access terminal.

2. The method of claim 1, wherein the narrowband PSR signal comprises an Association of Public-Safety Communications Officials (APCO) signal.

3. The method of claim 1, wherein the narrowband PSR signal comprises a Digital Mobile Radio (DMR) signal.

4. The method of claim 1, wherein the narrowband PSR signal comprises one or more of (i) an additional-capacity channel on the PSR network, (ii) a dedicated critical information channel on the PSR network, (iii) a broadcast channel on the PSR network, (iv) a control channel on the PSR network, (v) a direct mode discovery signal, (vi) a supplemental channel for supporting at least one service on the WWAN, and (vii) an administrative channel for coordination between the PSR network and the WWAN.

5. The method of claim 1, wherein the PSR network has a channel spacing, and wherein the WWAN has a subcarrier spacing that exceeds the channel spacing of the PSR network.

6. The method of claim 5, wherein the channel spacing of the PSR network is 12.5 kilohertz (kHz) and the subcarrier spacing of the WWAN is 15 kHz.

7. The method of claim 1, wherein the multicarrier wideband signal further comprises a positive integer number of neighboring null subcarriers deployed adjacent each side of the null DC subcarrier.

8. The method of claim 7, wherein the positive integer number is 1.

9. The method of claim 7, wherein the WWAN has a subcarrier spacing, and wherein the PSR network has a channel spacing that exceeds the subcarrier spacing of the WWAN.

10. The method of claim 9, wherein the channel spacing of the PSR network is 25 kilohertz (kHz), the subcarrier spacing of the WWAN is 15 kHz, and the positive integer number is 1.

11. The method of claim 1, further comprising selecting, based at least in part on a set of one or more factors, a transmission power level of the narrowband PSR signal, wherein the set of one or more factors includes a desired coverage range of the narrowband PSR signal.

12. The method of claim 11, wherein the set of one or more factors further includes an integer number of neighboring null subcarriers deployed adjacent each side of the null DC subcarrier in the multicarrier wideband signal.

13. The method of claim 1, further comprising selecting, based at least in part on a set of one or more factors, a transmission power level of the narrowband PSR signal, wherein the set of one or more factors includes an integer number of neighboring null subcarriers deployed adjacent each side of the null DC subcarrier in the multicarrier wideband signal.

14. The method of claim 1, further comprising selecting, based at least in part on a set of one or more factors, an integer number of neighboring null subcarriers deployed adjacent each side of the null DC subcarrier in the multicarrier wideband signal, wherein the set of one or more factors includes a desired coverage range of the narrowband PSR signal.

15. The method of claim 14, wherein the set of one or more factors further includes a transmission power level of the narrowband PSR signal.

16. The method of claim 1, further comprising selecting, based at least in part on a set of one or more factors, an integer number of neighboring null subcarriers deployed adjacent each side of the null DC subcarrier in the multicarrier wideband signal, wherein the set of one or more factors includes a transmission power level of the narrowband PSR signal.

17. The method of claim 1, wherein the multicarrier wideband signal comprises a plurality of traffic subcarriers, the plurality of traffic subcarriers including a pair of innermost traffic subcarriers, each of the two innermost traffic subcarriers deployed adjacent a respective side of the null DC subcarrier and any neighboring null subcarriers deployed adjacent each side of the null DC subcarrier, the method further comprising using a first modulation scheme on the innermost traffic subcarriers and using a second modulation scheme on the other traffic subcarriers in the plurality of traffic subcarriers, the first modulation scheme being of a lower order than the second modulation scheme.

18. The method of claim 17, further comprising using a first error-correction coding scheme on the innermost traffic subcarriers and using a second error-correction coding scheme on the other traffic subcarriers in the plurality of traffic subcarriers, the first error-correction coding scheme being stronger than the second error-correction coding scheme.

19. The method of claim 1, wherein the multicarrier wideband signal comprises a plurality of traffic subcarriers, the plurality of traffic subcarriers including a pair of innermost traffic subcarriers, each of the two innermost traffic subcarriers deployed adjacent a respective side of the null DC subcarrier and any neighboring null subcarriers deployed adjacent each side of the null DC subcarrier, the method further comprising using a first error-correction coding scheme on the innermost traffic subcarriers and using a second error-correction coding scheme on the other traffic subcarriers in the plurality of traffic subcarriers, the first error-correction coding scheme being stronger than the second error-correction coding scheme.

20. A system comprising:
a communication interface comprising a wireless-communication interface;
a processor; and
data storage containing instructions executable by the processor for causing the system to carry out a set of functions, the set of functions comprising:
generating a narrowband public-safety-radio (PSR) signal for transmission on a downlink of a PSR network;
generating a multicarrier wideband signal for transmission on a downlink of a wireless wide area network (WWAN), wherein the multicarrier wideband signal comprises a null DC subcarrier;
producing a combined signal, wherein the combined signal comprises the superposition of (i) the narrowband PSR signal centered on a characteristic frequency of the null DC subcarrier and (ii) the multicarrier wideband signal; and
transmitting the combined signal for receipt of the narrowband PSR signal at the characteristic frequency by at least one public-safety radio and receipt of the multicarrier wideband signal by at least one WWAN access terminal.
